(19) United States
(12) Patent Application Publication
(10) Pub. No.: US 2026/0122477 A1
(43) Pub. Date: Apr. 30, 2026

(54) COMMUNICATION METHOD AND APPARATUS

(71) Applicant: HUAWEI TECHNOLOGIES CO., LTD., Shenzhen (CN)

(72) Inventors: Yan Xi, Shanghai (CN); Xueqiang Yan, Shanghai (CN); Mingyu Zhao, Shanghai (CN)

(21) Appl. No.: 19/430,737

(22) Filed: Dec. 23, 2025

Related U.S. Application Data
(63) Continuation of application No. PCT/CN2023/103488, filed on Jun. 28, 2023.

(51) Int. Cl. H04W 8/24; H04W 74/0833

(52) U.S. Cl. CPC H04W 8/24; H04W 74/0833

(57) ABSTRACT

This application discloses a communication method and apparatus, and relates to the field of communication technologies. The communication method includes: receiving a first request message from a terminal apparatus, where the first request message is for requesting to provide a first data service; setting up a data bearer with the terminal apparatus; and sending a data service result corresponding to the first data service to the terminal apparatus through the data bearer. In this way, because an access network apparatus sets up the data bearer after determining that the terminal apparatus needs a data service, duration for maintaining the data bearer is reduced, and resource overheads are reduced.

### CROSS-REFERENCE TO RELATED APPLICATIONS

This is a continuation of International Patent Application No. PCT/CN2023/103488, filed on June 28, 2023, the disclosure of which is hereby incorporated by reference in its entirety.

### TECHNICAL FIELD

This application relates to the field of communication technologies, and in particular, to a communication method and apparatus.

### BACKGROUND

In a 5^{th} generation (5G) communication system, after a terminal apparatus accesses a network, the terminal apparatus, a base station, and a core network apparatus (for example, an access and mobility management function, (AMF)) collaboratively establish a protocol data unit (PDU) session. Then, if the base station or the core network apparatus (for example, a user plane function (UPF)) has data that needs to be transmitted to the terminal apparatus, the data is transmitted to the terminal apparatus through the PDU session. However, before the base station or the core network apparatus transmits the data to the terminal apparatus, the terminal device, the base station, and the core network apparatus still need to always maintain the PDU session. There is no doubt that a large quantity of resources of the terminal apparatus, the base station, the core network apparatus, and the like are consumed.

### SUMMARY

This application provides a communication method and apparatus, to reduce resource overheads.

According to a first aspect, an embodiment of this application provides a communication method. The method may be performed by an access network apparatus. The access network apparatus is, for example, a base station, a software module in a base station, or a hardware module (such as a chip) in a base station. The method includes: receiving a first request message from a terminal apparatus, where the first request message is for requesting to provide a first data service; setting up a data bearer with the terminal apparatus; and sending a data service result corresponding to the first data service to the terminal apparatus through the data bearer.

In this embodiment of this application, the access network apparatus sets up the data bearer after determining that the terminal apparatus needs the first data service, and provides data corresponding to the first data service for the terminal apparatus through the data bearer, without setting up the data bearer in advance. This reduces duration for maintaining the data bearer by the terminal apparatus and the access network apparatus, and reduces resource overheads of the terminal apparatus and the access network apparatus. In addition, a mechanism in which the terminal apparatus actively requests data from the access network apparatus is provided. In addition, in this embodiment of this application, the terminal apparatus exchanges data with the access network apparatus through data bearer instead of a PDU session, and another data exchange manner is provided.

In a possible implementation, before receiving the first request message from the terminal apparatus, the method further includes: sending first information, where the first information includes information about at least one indicated data service, and the first data service is one of the at least one data service.

In the foregoing implementation, the data service needed by the terminal apparatus belongs to a data service supported by the access network apparatus. This can ensure that the access network apparatus can smoothly provide a data service for the terminal apparatus. In addition, the access network apparatus may obtain, in advance, the data service needed by the terminal apparatus, to provide a data service for the terminal apparatus more specifically, and help provide a result with high accuracy corresponding to a data service for the terminal apparatus.

In a possible implementation, before receiving the first request message from the terminal apparatus, the method further includes: receiving a second request message from the terminal apparatus, where the second request message is for requesting to establish a connection, and indicates that a cause for requesting to establish the connection is to request to provide a data service; and sending a first response message to the terminal apparatus, where the first response message indicates that the connection is established, and the first request message from the terminal apparatus is received through the connection.

In the foregoing implementation, when requesting to establish a connection with the access network apparatus, the terminal apparatus may notify the access network apparatus that the connection is used for a subsequent data service, so that the access network apparatus prepares to provide a data service for the terminal apparatus earlier. In other words, timeliness of providing a data service for the terminal apparatus by the access network apparatus is improved.

In a possible implementation, before receiving the second request message from the terminal apparatus, the method further includes: receiving a first random access preamble from the terminal apparatus, where the first random access preamble indicates to establish the connection for the data service, and sending a random access response message to the terminal apparatus.

In the foregoing implementation, the first random access preamble may be a random access preamble corresponding to the data service. In other words, the first random access preamble is different from a random access preamble used by another service. This helps the access network apparatus determine, based on the first random access preamble, that the terminal apparatus needs the data service, thereby improving timeliness of providing the data service for the terminal apparatus by the access network apparatus, and avoiding a conflict between the first random access preamble and a random access preamble of the another service.

In a possible implementation, before setting up the data bearer with the terminal apparatus, the method further includes: sending a third request message to a first data control apparatus, where the third request message is for requesting to determine a data agent apparatus that provides the first data service; and receiving first indication information from the first data control apparatus, where the first indication information indicates that a first data agent apparatus is determined to provide the first data service. Optionally, the first data control apparatus may be deployed in a core network apparatus, or the first data control apparatus may be deployed independently relative to the core network apparatus, and the first data control apparatus may communicate with the core network apparatus.

In the foregoing implementation, before setting up the data bearer, the access network apparatus may determine, through the first data control apparatus, the first data agent apparatus configured to provide the first data service, to ensure that the access network apparatus smoothly provides a data service for the terminal apparatus subsequently.

In a possible implementation, the sending the third request message to the first data control apparatus includes: sending the third request message to the first data control apparatus through a second data control apparatus. Optionally, the second data control apparatus may be deployed in the access network apparatus, or the second data control apparatus may be deployed independently relative to the access network apparatus, and the second data control apparatus may communicate with the access network apparatus.

In the foregoing implementation, the access network apparatus may send the third request message to the first data control apparatus through the second data control apparatus, and a manner of sending the third request message is provided.

In a possible implementation, before setting up the data bearer with the terminal apparatus, the method further includes: determining, through a second data control apparatus, a first data agent apparatus that provides the first data service; and receiving first indication information from the second data control apparatus, where the first indication information indicates that the first data agent apparatus is determined to provide the first data service.

In the foregoing implementation, the second data control apparatus may determine the first data agent apparatus configured to provide the first data service, to ensure that the access network apparatus can smoothly provide the data service for the terminal apparatus subsequently. In a case in which the first data agent apparatus is independently deployed relative to the core network apparatus, it is equivalent to that the access network apparatus, the second data control apparatus, and the first data agent apparatus collaboratively provide the data service for the terminal apparatus, without participation of the core network apparatus, thereby simplifying a data service process.

In a possible implementation, the first request message is a radio resource control message or a non-access stratum message. In the foregoing implementation, an existing message may be reused for the first request message, and no additional message is added. This helps reduce a quantity of message transmissions between the access network apparatus and the terminal apparatus, thereby reducing network transmission burden.

In a possible implementation, before receiving a first request message from the terminal apparatus, the method further includes: sending second information, where the second information indicates that the access network apparatus has a data service capability.

In the foregoing implementation, the access network apparatus may notify the terminal apparatus that the access network apparatus has the data service capability, thereby avoiding a case in which the terminal apparatus requests the data service from the access network apparatus but the access network apparatus does not have the data service capability, that is, reducing an invalid interaction between the terminal apparatus and the access network apparatus.

In a possible implementation, after exchanging, with the terminal apparatus through the data bearer, the data corresponding to the first data service, the method further includes: deleting the data bearer, and sending a fourth request message to the terminal apparatus, where the fourth request message indicates to delete the data bearer; and receiving a second response message from the terminal apparatus, where the second response message indicates that the data bearer is deleted.

In the foregoing implementation, after providing the first data service, the access network apparatus may delete the data bearer, and notify the terminal apparatus to delete the data bearer, to release, in a timely manner, resources occupied by the data bearer. These released resources may be used for other purposes, thereby improving overall resource utilization.

According to a second aspect, an embodiment of this application provides a communication method. The method may be performed by a terminal apparatus. The terminal apparatus is, for example, a terminal device, or a software or hardware module (such as a chip) in the terminal device. The method includes: sending a first request message to an access network apparatus, where the first request message is for requesting to provide a first data service; setting up a data bearer with the access network apparatus; and exchanging, with the access network apparatus through the data bearer, data corresponding to the first data service.

In a possible implementation, before sending the first request message to the access network apparatus, the method further includes: receiving first information from the access network apparatus, where the first information includes information about at least one data service supported by the access network apparatus, and the first data service is one of the at least one data service.

In a possible implementation, before sending the first request message to the access network apparatus, the method further includes: sending a second request message to the access network apparatus, where the second request message is for requesting to establish a connection, and indicates that a cause for requesting to establish the connection is to request to provide a data service; and receiving a first response message from the access network apparatus, where the first response message indicates that the connection is established, and the first request message is sent to the access network apparatus through the connection.

In a possible implementation, the method further includes: sending a first random access preamble to the access network apparatus, where the first random access preamble indicates to establish the connection for the data service; and receiving a random access response message from the access network apparatus.

In a possible implementation, the first request message is a radio resource control message or a non-access stratum message.

In a possible implementation, the method further includes: receiving second information, where the second information indicates that the access network apparatus has a data service capability.

In a possible implementation, after exchanging, with the access network apparatus through the data bearer, the data corresponding to the first data service, the method further includes: receiving a fourth request message from the access network apparatus, where the fourth request message indicates to delete the data bearer; deleting the data bearer; and sending a second response message to the access network apparatus, where the second response message indicates that the data bearer is deleted.

According to a third aspect, an embodiment of this application provides a communication apparatus. The communication apparatus may be the access network apparatus in the first aspect, a software module or a hardware module in the access network apparatus, or the like. The access network apparatus includes a corresponding means or module configured to perform the first aspect or any possible implementation. For example, the communication apparatus includes a processing module (sometimes also referred to as a processing unit) and a transceiver module (sometimes also referred to as a transceiver unit).

For example, under control of the processing module, the transceiver module is configured to receive a first request message from a terminal apparatus, where the first request message is for requesting to provide a first data service; set up a data bearer with the terminal apparatus; and exchange, with the terminal apparatus through the data bearer, data corresponding to the first data service.

Optionally, the communication apparatus may further perform any possible implementation performed by the access network apparatus in the first aspect. For repeated content, refer to content in the first aspect and any possible implementation above.

According to a fourth aspect, an embodiment of this application provides a communication apparatus. The communication apparatus may be the terminal apparatus in the second aspect, a software module or a hardware module in the terminal apparatus, or the like. The terminal apparatus includes a corresponding means or module configured to perform the second aspect or any possible implementation. For example, the communication apparatus includes a processing module (sometimes also referred to as a processing unit) and a transceiver module (sometimes also referred to as a transceiver unit).

For example, under control of the processing module, the transceiver module is configured to send a first request message to an access network apparatus, where the first request message is for requesting to provide a first data service; set up a data bearer with the access network apparatus; and exchange, with the access network apparatus through the data bearer, data corresponding to the first data service.

Optionally, the communication apparatus may further perform any possible implementation performed by the terminal apparatus in the first aspect. For repeated content, refer to content in the second aspect and any possible implementation above.

According to a fifth aspect, an embodiment of this application provides a communication system. The communication system includes any communication apparatus in the third aspect and any communication apparatus in the fourth aspect.

According to a sixth aspect, an embodiment of this application provides a communication apparatus, including a processor and an interface circuit. The interface circuit is configured to receive a signal from a communication apparatus other than the communication apparatus and transmit the signal to the processor, or send a signal from the processor to a communication apparatus other than the communication apparatus. The processor is configured to implement the method according to any one of the first aspect or the second aspect through a logic circuit or by executing code instructions.

In a specific implementation process, the communication apparatus may be a chip, and the processor may be a transistor, a gate circuit, a trigger, various logic circuits, or the like. A specific implementation of the processor is not limited in this embodiment of this application.

In a possible implementation, the communication apparatus may be a wireless communication device, that is, a computer device that supports a wireless communication function. Specifically, the wireless communication device may be a terminal, for example, a smartphone, or may be a radio access network device, for example, a base station. A system chip may also be referred to as a system-on-a-chip (SoC), or briefly referred to as a SoC chip. A communication chip may include a baseband processing chip and a radio frequency processing chip. The baseband processing chip is also sometimes referred to as a modem or a baseband chip. The radio frequency processing chip is also sometimes referred to as a radio frequency transceiver or a radio frequency chip. In a physical implementation, some or all chips of the communication chip may be integrated into the SoC chip. For example, the baseband processing chip is integrated into the SoC chip, but the radio frequency processing chip is not integrated into the SoC chip. The interface circuit may be a radio frequency processing chip in the wireless communication device, and the processor may be a baseband processing chip in the wireless communication device.

In another possible implementation, the communication apparatus may be a part of devices in the wireless communication device, for example, an integrated circuit product such as a system chip or a communication chip. The interface circuit may be an input/output interface, an interface circuit, an output circuit, an input circuit, a pin, a related circuit, or the like on the chip or a chip system. The processor may alternatively be embodied as a processing circuit or a logic circuit.

According to a seventh aspect, an embodiment of this application provides a communication apparatus, including a processor and a memory. The memory is configured to store one or more computer programs, and the one or more computer programs include computer-executable instructions; and when the communication apparatus is run, the processor executes the one or more computer programs stored in the memory, to cause the communication apparatus to perform the method according to any one of the first aspect and the second aspect.

Optionally, the communication apparatus further includes another component, for example, at least one of an antenna, an input/output module, or an interface. Such components may be hardware, software, or a combination of software and hardware.

According to an eighth aspect, an embodiment of this application provides a chip system. The chip system includes a processor and an interface. The processor is configured to invoke instructions from the interface and run the instructions. When the processor executes the instructions, the method according to any one of the first aspect or the second aspect is implemented.

According to a ninth aspect, an embodiment of this application provides a computer-readable storage medium. The computer-readable storage medium is configured to store a computer program or instructions. When the computer program or the instructions are run, the method according to any one of the first aspect or the second aspect is implemented.

According to a tenth aspect, an embodiment of this application provides a computer program product including instructions. When the instructions are run on a computer, the method according to any one of the first aspect or the second aspect is implemented.

For beneficial effects of any one of the technical solutions in the second aspect to the tenth aspect, refer to the beneficial effects of the corresponding technical solution in the first aspect. Repeated content is not listed herein again.

### BRIEF DESCRIPTION OF DRAWINGS

FIG. 1 is a diagram of a scenario to which an example embodiment of this application is applicable;

FIG. 2 is an example diagram of a PDU session establishment process;

FIG. 3 is an architectural diagram of a data plane to which an example embodiment of this application is applicable;

FIG. 4 is a diagram of a scenario according to an example embodiment of this application;

FIG. 5 is a diagram of another scenario according to an example embodiment of this application;

FIG. 6 is a diagram of still another scenario according to an example embodiment of this application;

FIG. 7 is a diagram of still another scenario according to an example embodiment of this application;

FIG. 8 is a diagram of user plane protocol stacks of a terminal apparatus and an access network apparatus according to an example embodiment of this application;

FIG. 9 is a diagram of a communication method according to an example embodiment of this application;

FIG. 10 is a diagram of another communication method according to an example embodiment of this application;

FIG. 11 is a diagram of still another communication method according to an example embodiment of this application;

FIG. 12 is a diagram of a structure of a communication apparatus according to an example embodiment of this application;

FIG. 13 is a diagram of a structure of another communication apparatus according to an example embodiment of this application; and

FIG. 14 is a diagram of a structure of still another communication apparatus according to an example embodiment of this application.

### DESCRIPTION OF EMBODIMENTS

The following describes in detail embodiments of this application with reference to accompanying drawings.

The terms "system" and "network" may be used interchangeably in embodiments of this application. "At least one" means one or more, and "a plurality of" means two or more. "And/or" describes an association relationship between associated objects and indicates that at least three relationships may exist. For example, A and/or B may indicate the following three cases: Only A exists, both A and B exist, and only B exists, where A and B may be singular or plural. The character "/" generally indicates an "or" relationship between associated objects. "At least one of the following items (pieces)" or a similar expression thereof means any combination of these items, including any combination of a single item or a plurality of items (pieces). For example, at least one item (piece) of a, b, or c may represent a, b, c, a and b, b and c, a and c, or a, b, and c.

In addition, unless otherwise stated, ordinal numbers such as "first" and "second" in embodiments of this application are for distinguishing between a plurality of objects, but are not intended to limit a sequence, a time sequence, priorities, or importance of the plurality of objects. For example, first information and second information are merely used to distinguish between different information, but do not indicate that the two types of information are different in a sending sequence, a receiving sequence, importance, or the like.

In addition, the terms "include" and "have" in embodiments of this application, the claims, and the accompanying drawings are not exclusive. For example, a process, a method, a system, a product, or a device that includes a series of steps or modules is not limited to the listed steps or modules, and may further include steps or modules that are not listed.

FIG. 1 is a diagram of a scenario to which an embodiment of this application is applicable. Alternatively, FIG. 1 may be considered as a diagram of a communication system to which an embodiment of this application is applicable. As shown in FIG. 1, the scenario includes a terminal apparatus, an access network apparatus, and a core network (CN) apparatus. The terminal apparatus may access the core network apparatus through the access network apparatus.

The terminal apparatus may be a terminal device, a software module or a hardware module (for example, a chip) in the terminal device, or the like. The terminal device is a device having a wireless transceiver function, and may be a fixed device, a mobile device, a handheld device, a wearable device, a vehicle-mounted device, or a wireless apparatus (for example, a communication module or a chip system) built in the foregoing device. The terminal apparatus is configured to connect a person, an object, a machine, and the like, and may be a terminal apparatus widely used in various scenarios, for example, including but not limited to the following scenarios: cellular communication, device-to-device (D2D) communication, vehicle-to-everything (V2X), machine-to-machine/machine-type communication (M2M/MTC), internet of things (IoT), virtual reality (VR), augmented reality (AR), industrial control, self-driving, telemedicine (remote medical), smart grid, smart furniture, smart office, smart wearable, smart transportation, smart city, uncrewed aerial vehicle, robot, and the like. The terminal apparatus may be sometimes referred to as user equipment (UE), a terminal, an access station, a UE station, a remote station, a wireless communication device, a user apparatus, or the like.

The access network apparatus may also be referred to as an access network element, an access network device, or the like. The access network apparatus is a device having a wireless transceiver function, and is configured to communicate with the terminal apparatus. The access network apparatus includes but is not limited to a base station (BTS, NodeB, eNodeB/eNB, or gNodeB/gNB) in the foregoing communication system, a transmission reception point (TRP), a base station subsequently evolved in a 3GPP, an access node in a wireless fidelity (Wi-Fi) system, a radio relay node, a wireless backhaul node, a satellite, an uncrewed aerial vehicle, or the like. The base station may be a macro base station, a micro base station, a picocell base station, a small cell, a relay station, or the like. The base station may include one or more co-site or non-co-site transmission reception points. Alternatively, the access network apparatus may be a radio controller in a cloud radio access network (C(R)AN) scenario. Alternatively, the access network apparatus may be a server, a wearable device, a vehicle-mounted device, or the like. For example, an access network apparatus in a vehicle-to-everything (V2X) technology may be a road side unit (RSU). An example in which the access network apparatus is a base station is used below for description. A plurality of base stations in the communication system support networks of a same access technology mentioned above, or support networks of different access technologies mentioned above. A plurality of access network apparatuses may be a same type of base stations, or may be different types of base stations. The base station may communicate with the terminal apparatus, or may communicate with the terminal apparatus through a relay station. The terminal apparatus may communicate with a plurality of base stations in different access technologies.

In a possible architecture of the access network apparatus, the access network apparatus includes a central unit (CU) and/or a distributed unit (DU). The CU and the DU may be understood as division of the access network apparatus from a perspective of logical functions. The CU and the DU may be physically separated, or may be deployed together. This is not specifically limited in embodiments of this application. One CU may be connected to one DU, or a plurality of DUs may share one CU. The CU and the DU may be split based on a protocol stack. In a possible manner, a radio resource control (RRC) layer, a service data adaptation protocol stack (SDAP) layer, and a packet data convergence protocol (PDCP) layer are deployed on the CU, and a remaining radio link control (RLC) layer, media access control (MAC) layer, physical (PHY) layer, and the like are deployed on the DU. In embodiments of this application, the CU and the DU are not completely limited to being split in the foregoing protocol stack manner. There may be another split manner, for example, split based on a service type.

The access network apparatus in embodiments of this application may alternatively be a central unit control plane (CU-CP) node or a central unit user plane (CU-UP) node, or may include a CU-CP and a CU-UP. The CU-CP is responsible for a control plane function, and mainly includes RRC and a PDCP-C. The PDCP-C is mainly responsible for encryption and decryption, integrity protection, data transmission, and the like of control plane data. The CU-UP is responsible for a user plane function, and mainly includes an SDAP and a PDCP-U. The SDAP is mainly responsible for processing data of a core network and mapping a flow to a bearer. The PDCP-U is mainly responsible for encryption/decryption, integrity protection, header compression, sequence number maintenance, data transmission, and the like of a data plane.

In different systems, the CU (including the CU-CP and the CU-UP) or the DU may also have different names, but a person skilled in the art may understand meanings thereof. For example, in an open radio access network (O-RAN) system, the CU may also be referred to as an O-CU (open CU), the DU may also be referred to as an O-DU, the CU-CP may also be referred to as an O-CU-CP, and the CU-UP may also be referred to as an O-CU-UP.

The core network apparatus is configured to implement at least one of functions such as mobility management, data processing, session management, and policy and charging. The scenario shown in FIG. 1 may include one or more core network apparatuses. In FIG. 1, an example in which a quantity of core network apparatuses is 1 is used, but the quantity of core network apparatuses is not limited. The core network apparatus may also be referred to as a core network element or a core network device. Names of devices that implement functions of a core network in systems using the different access technologies may be different. This is not limited in embodiments of this application. An example of a 5G system is used, the core network apparatus includes at least one of an AMF, a session management function (SMF), and a UPF, and the like.

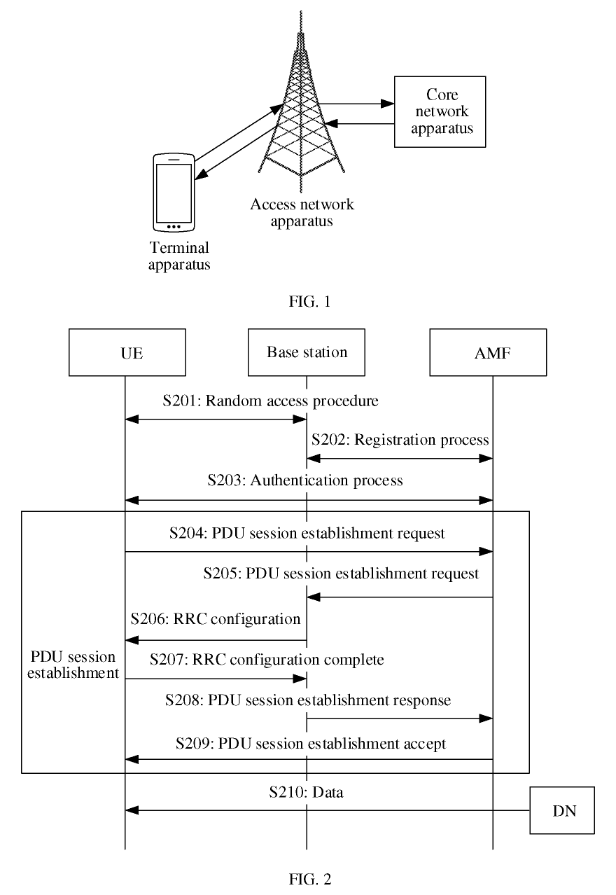

The following describes a PDU session establishment process in the background by using an example in which the terminal apparatus in FIG. 1 is UE, the access network apparatus in FIG. 1 is a base station, and the core network apparatus in FIG. 1 includes an AMF. FIG. 2 shows a PDU session establishment process. FIG. 2 includes steps shown in S201 to S210, and the following separately describes the steps.

S201: Random access procedure: UE may interact with a base station to perform random access, to access the base station.

S202: Registration process: The base station may register information about the UE with an AMF, so that the AMF determines the information about the UE.

S203: Authentication process: The AMF may authenticate the UE based on the information about the UE.

S204: The UE sends a PDU session establishment request to the AMF. Correspondingly, the AMF receives the PDU session establishment request from the UE.

S205: The AMF sends a PDU session establishment request to the base station. Correspondingly, the base station receives the PDU session establishment request from the AMF.

S206: The base station sends RRC reconfiguration to the UE. Correspondingly, the UE receives the RRC reconfiguration from the base station.

S207: The UE sends RRC reconfiguration complete to the base station. Correspondingly, the base station receives the RRC reconfiguration complete from the UE.

S208: The base station sends a PDU session establishment response to the AMF. Correspondingly, the AMF receives the PDU session establishment response from the base station.

S209: The AMF sends PDU session establishment accept to the UE. Correspondingly, the UE receives the PDU session establishment accept from the AMF.

S210: A data network (DN) sends data to the UE. Correspondingly, the UE receives the data from the DN. The DN sends the data to the UE through the PDU session.

It can be learned from FIG. 2 that, after the UE accesses the network, the UE, the base station, and the AMF collaboratively establish a PDU session. Even if the base station or a core network apparatus (for example, a UPF) currently does not have data that needs to be transmitted to a terminal apparatus, the UE, the base station, and the core network apparatus (for example, the UPF) still need to maintain a PDU session, to subsequently transmit data based on the PDU session. Consequently, resource overheads are high.

In view of this, an embodiment of this application provides a communication method. In the communication method, a terminal apparatus may actively request a data service from an access network apparatus. After determining that the terminal apparatus needs the data service, the access network apparatus sets up a data bearer with the terminal apparatus, and provides the data service for the terminal apparatus through the data bearer. Because the access network apparatus sets up the data bearer only after determining that the terminal apparatus needs the data service, and does not set up the data bearer in advance, duration for maintaining the data bearer by the access network apparatus and the terminal apparatus is reduced, and resource overheads are reduced.

In a possible implementation, the data service in the method provided in embodiments of this application may be performed by the access network apparatus through an apparatus on a data plane. The following describes related content of the data plane.

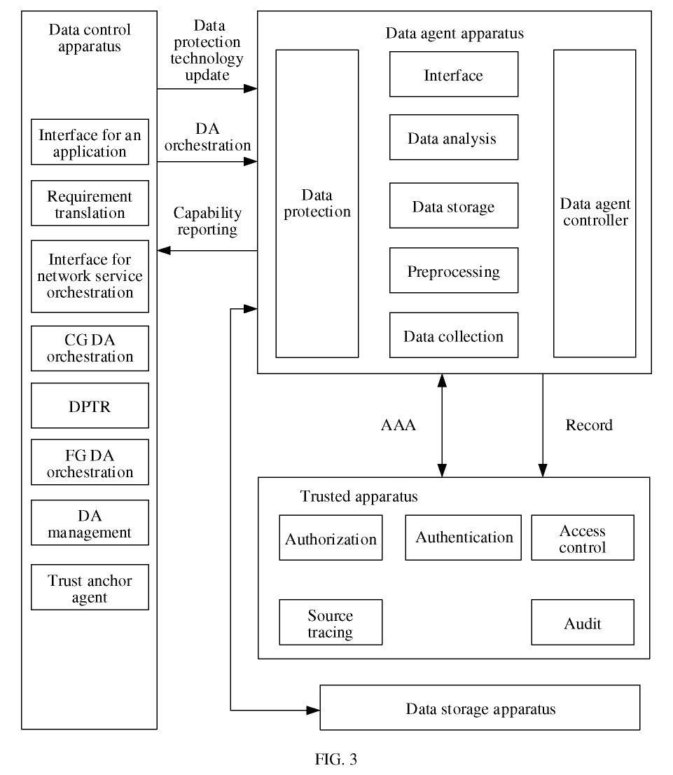

The data plane aims to build a unified and trusted data service framework to resolve a problem of data silos. In addition to meeting regulatory requirements of data laws and regulations, the data plane provides a trusted data service to implement cross-domain and cross-manufacturer data sharing, improve operation efficiency, and monetize data value. With reference to an architectural diagram of a data plane shown in FIG. 3, the following provides example description of a data plane architecture to which an embodiment of this application is applicable. As shown in FIG. 3, the data plane includes a data agent (DA) apparatus, a data control apparatus, a trusted apparatus, and a data storage apparatus. The DA apparatus, the data control apparatus, the trusted apparatus, and the data storage apparatus may be logical entities or physical entities. This is not limited in embodiments of this application. The following separately describes the apparatuses.

1. The DA apparatus is configured to process (or perform) a data service. The data service may also be referred to as a data service task, a data service business, or the like. The DA apparatus may also be referred to as a data processing apparatus, a data processing device, a data agent apparatus, a data agent device, a data agent entity, a data agent network element, or the like. This is not limited in embodiments of this application.

Optionally, the DA apparatus may be deployed in a centralized manner or in a distributed manner. The DA apparatus may be deployed in any core network apparatus, transfer network (TN) apparatus, access network apparatus, or another apparatus/device/network element (for example, an operation, administration, and maintenance (OAM) apparatus (or network element)). Alternatively, the DA apparatus may be independently deployed relative to a CN and a TN. For example, the DA apparatus may be independently deployed in a network as a network function (NF) or a network element. In a possible implementation, the DA apparatus may be evolved from a network data analytics function (NWDAF) network element, and can implement a function of the NWDAF network element and support various data analysis technologies. In another possible implementation, the DA apparatus and the NWDAF network element may be separately deployed. For example, the NWDAF network element invokes, through an API, data services of the DA apparatus at various layers such as data collection, preprocessing, or storage.

When the data plane includes a plurality of DA apparatuses, some of the plurality of DA apparatuses may be deployed in one or more communication apparatuses (such as a core network apparatus, a terminal apparatus, an access network apparatus, or another communication apparatus), and the other part of the plurality of DA apparatuses is independently deployed; or all the plurality of DA apparatuses are deployed in one or more communication apparatuses (such as a core network apparatus, a terminal apparatus, an access network apparatus, or another communication apparatus); or the plurality of DA apparatuses are independently deployed in a network. This is not limited in embodiments of this application. Any two DA apparatuses in the plurality of DA apparatuses may provide same or different data services, and correspondingly, the two DAs may implement same or different functions.

For example, functions that can be implemented by the DA apparatus include but are not limited to one or more of the following: reporting a capability (for example, interacting with the data control apparatus, where specifically, the DA apparatus reports a capability to the data control apparatus), providing an interface (for example, an application programming interface (API)), interacting with the trusted apparatus, data analysis, data storage, preprocessing, data collection, data protection, a data agent controller (DA controller), and the like.

It may be understood that, in embodiments of this application, functional modules of the DA apparatus may be obtained through division based on the foregoing functions or the following method embodiments. For example, each functional module may be obtained through division based on each corresponding function, or two or more functions may be integrated into one module. The integrated module may be implemented in a form of hardware, or may be implemented in a form of a software functional module. In embodiments of this application, functional division or division into modules is an example, and is merely logical functional division. During actual implementation, another division manner may be used.

2. The data control apparatus may be a data orchestration (DO) apparatus, a data controller (DC) apparatus, a component in a data orchestration apparatus, a component in a DC apparatus, a combination of a data orchestration apparatus and a DC apparatus, or a data controller in a data orchestration apparatus. This is not limited in embodiments of this application. Optionally, the data control apparatus may also be referred to as a data control device, a data control network element, a data orchestration apparatus, a data orchestration network element, a data orchestration entity, a data orchestration device, or the like. The following uses an example in which the data control apparatus is a DC apparatus, that is, the data control apparatus can implement a function of the DC apparatus. The DC apparatus may be a logical entity or a physical entity.

The DC apparatus may be deployed in any core network apparatus, transfer network apparatus, access network apparatus, or another apparatus/device/network element (for example, an OAM network element), or the DC apparatus may be independently deployed. For example, the DC apparatus may be hierarchically deployed in a CN or a RAN. For example, the DC apparatus may be deployed in a network service (NS) network element. For another example, the DC apparatus may be independently deployed in a network as an NF or a network element. In actual deployment, one or more NFs may form one network element. A DC deployed in the core network apparatus or a DC apparatus that can communicate with the core network apparatus is referred to as a core network data controller (CN-DC) for short. Similarly, a DC apparatus deployed in the access network apparatus or a DC apparatus that can communicate with the access network apparatus may be referred to as a radio access network data controller (RAN-DC) for short.

For example, functions that may be implemented by the DC apparatus include but are not limited to one or more of the following: an interface for providing an application, requirement translation, an interface for network service orchestration, a data security protection and privacy protection technology repository ( DPTR), coarse-grained (CG) DA orchestration, fine-grained (FG) DA orchestration, DA management, a trust anchor agent, or the like.

The DC apparatus may include a data orchestrator and a data controller. For example, the DC apparatus may be divided into the data orchestrator and the data controller based on real-time performance and a cross-domain situation of a task. For example, the data orchestrator and the data controller collaboratively achieve flexibility and programmability of a data pipeline. The following describes functions of the data orchestrator and the data controller. It should be understood that the DC apparatus can implement functions of the data orchestrator and functions of the data controller.

The data orchestrator is responsible for coarse-grained and non-real-time data orchestration. For example, the data orchestrator mainly has one or more of the following functions: receiving a data service request, and converting the data service request into a data pipeline combination request; cooperating with another network service, for example, cooperating with a computational power network service, where the computational power network service orchestrates computational power, and the data orchestrator orchestrates data; and implementing cross-domain coarse-grained data pipeline orchestration based on the data service request and a service capability of the DA apparatus. Alternatively, the data orchestrator may be built with a data security protection and privacy protection repository (DPTR), for example, including technologies such as differential privacy, homomorphic encryption, secure multi-party computing, or zero-knowledge proof, to provide a data security and privacy protection capability and empower a data protection technology (DPT) to the DA apparatus based on a requirement.

The data controller is mainly responsible for a fine-grained real-time orchestration task. For example, the data controller mainly has one or more of the following functions: implementing fine-grained DA apparatus orchestration; combining data pipelines in a local domain based on a capability of the DA apparatus and the data service request, to implement real-time and efficient service management; receiving a capability report of the DA apparatus and implementing registration and revocation functions of the DA apparatus; and implementing real-time supervision of the DA apparatus by monitoring a heartbeat of a data agent. Alternatively, the data controller may be built with a trust anchor client (TAC), to initiate a request for security mechanisms such as authentication, authorization, and access control to a trust anchor agent (TAA), and apply for source tracing and auditing services for data access, and the like.

It may be understood that, in embodiments of this application, the foregoing functions of the DC apparatus may be integrated into one module based on the foregoing functions or the following method embodiments. The integrated module may be implemented in a form of hardware, or may be implemented in a form of a software functional module. In embodiments of this application, functional division or division into modules is an example, and is merely logical functional division. During actual implementation, another division manner may be used.

3. The trusted apparatus may be a trust anchor (TA), and may be configured to provide a security service such as authentication, authorization, and accounting (AAA), store data that cannot be tampered with, a public key of a terminal apparatus or a network element (NE), data that has a small data amount but cannot be tampered with, or other important data that cannot be tampered with. Deployment of the trusted apparatus is not limited in embodiments of this application. For example, functions that can be implemented by the trusted apparatus include but are not limited to one or more of the following: authorization, authentication, access control, source tracing, audit, and the like.

4. The data storage apparatus is, for example, a data storage function (DSF). The data storage apparatus is configured to store data, for example, configured to store raw data or a data processing result in a data processing process of the DA apparatus.

The method provided in embodiments of this application may be applied to a communication system in which a data plane is deployed, for example, a 5G communication system in which a data plane is deployed (for example, a new radio (NR) system), a 6G communication system in which a data plane is deployed, or a future evolved communication system or another similar communication system in which a data plane is deployed. Another type of communication system is, for example, an air interface communication system or a sidelink (sidelink) communication system. The sidelink communication system is, for example, a vehicle-to-X (V2X) or device-to-device (D2D) communication system. This is not specifically limited in embodiments of this application. The following describes a communication system in which a data plane is deployed.

FIG. 4 is a diagram of a scenario according to an embodiment of this application. Alternatively, FIG. 4 may be considered as a diagram of deployment of a DA apparatus and a DC apparatus, or may be considered as a diagram of a structure of a communication system in which a data plane is deployed. In FIG. 4, an example in which the DC apparatus is independently deployed relative to a core network apparatus and an access network apparatus is used.

FIG. 4 shows a terminal apparatus, the access network apparatus, the core network apparatus, a first DC apparatus, a second DC apparatus, and a first DA apparatus. The terminal apparatus may communicate with the access network apparatus, and the access network apparatus may communicate with the core network apparatus. The access network apparatus may communicate with the second DC apparatus. The second DC apparatus may also communicate with the first DC apparatus. The core network apparatus may communicate with the first DC apparatus. The first DC apparatus may communicate with the first DA apparatus. The core network apparatus includes, for example, an AMF.

In FIG. 4, an example in which a quantity of DC apparatuses is 2 and a quantity of DA apparatuses is 1 is used for description. Actually, the quantity of DC apparatuses and the quantity of DA apparatuses are not limited.

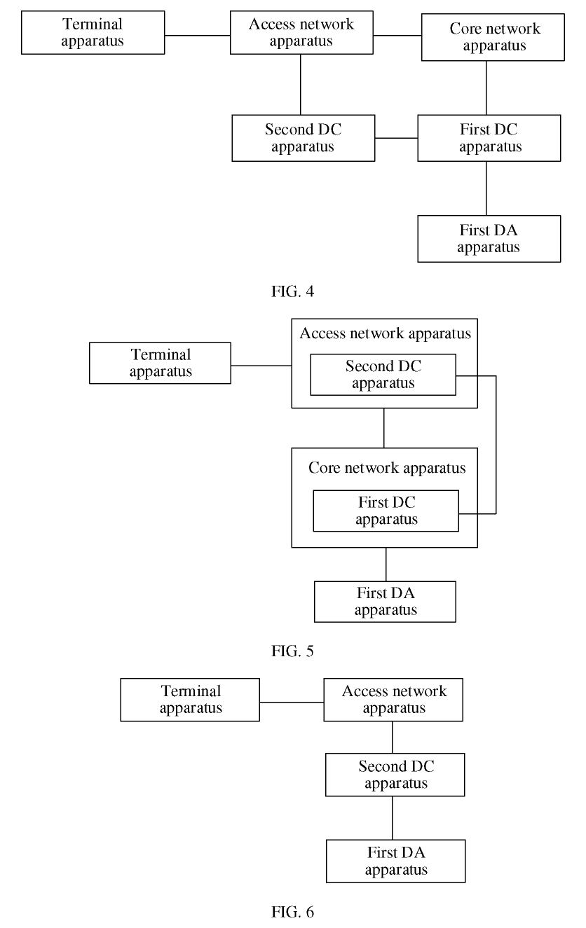

FIG. 5 is a diagram of another scenario according to an embodiment of this application. Alternatively, FIG. 5 may be considered as a diagram of other deployment of a DA apparatus and a DC apparatus, or may be considered as a diagram of a structure of a communication system in which a data plane is deployed. Different from FIG. 4, in FIG. 5, an example in which the DC apparatus is deployed in a core network apparatus or an access network apparatus is used.

FIG. 5 shows a terminal apparatus, the access network apparatus, the core network apparatus, and a first DA apparatus. A second DC apparatus may be deployed in the access network apparatus, and the second DC apparatus may communicate with a first DC apparatus. The first DC apparatus may be deployed in the core network apparatus. The terminal apparatus may communicate with the access network apparatus, and the access network apparatus may communicate with the core network apparatus.

In FIG. 5, an example in which the first DA apparatus and the core network apparatus are independently deployed is used. Actually, the first DA apparatus may alternatively be deployed in the core network apparatus.

In FIG. 5, an example in which a quantity of DC apparatuses is 2 and a quantity of DA apparatuses is 1 is used for description. Actually, the quantity of DC apparatuses and the quantity of DA apparatuses are not limited.

FIG. 6 is a diagram of still another scenario according to an embodiment of this application. Alternatively, FIG. 6 may be considered as a diagram of other deployment of a DA apparatus and a DC apparatus, or may be considered as a diagram of a structure of a communication system in which a data plane is deployed. Different from FIG. 4, FIG. 6 does include a first DC apparatus and a core network apparatus, and in FIG. 6, a first DA apparatus may communicate with a second DC apparatus.

FIG. 6 shows a terminal apparatus, an access network apparatus, the second DC apparatus, and the first DA apparatus. As shown in FIG. 6, the terminal apparatus communicates with the access network apparatus. The access network apparatus may communicate with the second DC apparatus, and the second DC apparatus may communicate with the first DA apparatus.

In FIG. 6, an example in which a quantity of DC apparatuses is 1 and a quantity of DA apparatuses is 1 is used for description. Actually, the quantity of DC apparatuses and the quantity of DA apparatuses are not limited.

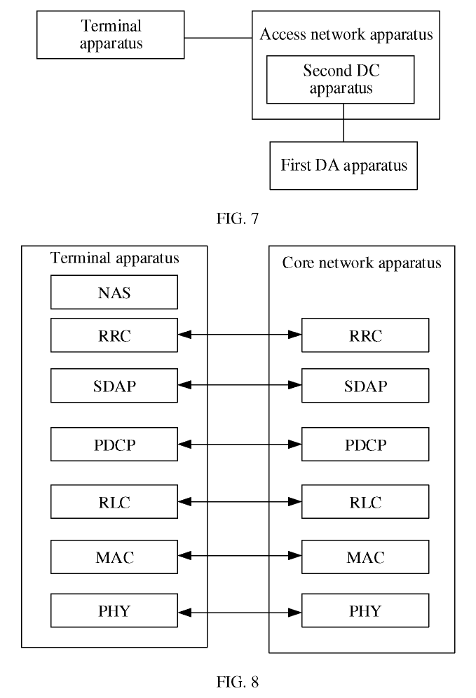

FIG. 7 is a diagram of still another scenario according to an embodiment of this application. Alternatively, FIG. 7 may be considered as a diagram of other deployment of a DA apparatus and a DC apparatus, or may be considered as a diagram of a structure of a communication system in which a data plane is deployed. Different from FIG. 6, in FIG. 7, a second DC apparatus is deployed in an access network apparatus.

FIG. 7 shows a terminal apparatus, the access network apparatus, and a first DA apparatus. The second DC apparatus may communicate with the first DA apparatus. In FIG. 7, an example in which a quantity of DC apparatuses is 1 and a quantity of DA apparatuses is 1 is used for description. Actually, the quantity of DC apparatuses and the quantity of DA apparatuses are not limited.

The first DC apparatus in any one of FIG. 4 to FIG. 7 may be deployed in the core network apparatus, or may communicate with the core network apparatus. Therefore, the first DC apparatus may also be referred to as a CN-DC. The second DC apparatus in any one of FIG. 4 to FIG. 7 may be deployed in the access network apparatus, or may communicate with the access network apparatus. Therefore, the second DC apparatus may also be referred to as a RAN-DC.

It should be understood that FIG. 4 to FIG. 7 show several deployment forms of the DA apparatus and the DC apparatus. Actually, the DA apparatus and the DC apparatus may be deployed in a plurality of manners. For example, the first DA apparatus in any one of FIG. 4 to FIG. 7 may alternatively be deployed in the access network apparatus. This is not specifically limited in embodiments of this application.

After the scenarios to which embodiments of this application may be applied are described, the following provides example description of user plane protocol stacks of the terminal apparatus and the access network apparatus in any one of the foregoing scenarios in FIG. 1 and FIG. 4 to FIG. 7.

FIG. 8 is a diagram of user plane protocol stacks of a terminal apparatus and an access network apparatus according to an embodiment of this application.

As shown in FIG. 8, the user plane protocol stack of the terminal apparatus includes a non-access stratum (NAS), an RRC layer, an SDAP layer, a PDCP layer, an RLC layer, a MAC layer, and a PHY layer. The user plane protocol stack of the access network apparatus may include an RRC layer, an SDAP layer, a PDCP layer, an RLC layer, a MAC layer, and a PHY layer. The following describes the layers.

### 1. NAS stratum

The NAS stratum is mainly used for connection and mobility control between the terminal apparatus and a core network apparatus (such as an AMF). Although the core network apparatus receives a message from the access network apparatus, the message is not initially sent by the access network apparatus. The access network apparatus only transparently transmits a message sent by the terminal apparatus to the core network apparatus, and cannot identify or change the message. Therefore, the message is referred to as a NAS message. The NAS message is an interaction between the terminal apparatus and the core network apparatus, for example, a mobility and connection process message such as attach, bearer setup, or service request.

### 2. RRC layer

The RRC layer is mainly used for processing all signaling between the terminal apparatus and the access network apparatus, including a system message, admission control, security management, cell reselection, measurement reporting, handover and mobility, NAS message transmission, radio resource management, and the like.

### 3. SDAP layer

The SDAP layer is located above the packet data convergence protocol (PDCP) layer, directly carries an internet protocol (IP) data packet, and may be used on a user plane. The SDAP layer is responsible for mapping between a quality of service (QoS) flow and a data resource bearer (data radio bearer, DRB), and adding a quality of service flow identifier (QFI) tag to a data packet.

### 4. PDCP layer

Main functions of the PDCP layer in 5G may include at least one of the following: (1) user-plane IP header compression (where a compression algorithm may be determined by both a mobile phone and a base station); (2) encryption/decryption (control plane/user plane); (3) control-plane integrity check (where there is only a control plane in 4G, and a user plane in 5G can be selectively checked); (4) sorting and replication detection; and (5) in an Option3X architecture for NSA networking, a PDCP of the access network apparatus (such as a gNodeB) performs traffic splitting, and provides a routing function.

### 5. RLC layer

The RLC layer is located below the PDCP layer. RLC is located at an L2 layer in an air interface protocol stack, and is between a PDCP and MAC in the L2. The RLC layer provides three data transmission services at the radio link layer: transparent mode (TM), unacknowledged mode (UM), and acknowledged mode (AM). The TM may be used for transmitting a broadcast message, the UM may be used for transmitting a service that has a delay requirement, such as a voice service, and the AM may be used for transmitting a common service, and has high accuracy. Main functions of the RLC layer are as follows.

(1) Segmentation and reassembly: A size of a segmented data packet is determined by the MAC. For example, if a radio environment is good, the size of the segmented data packet may be large; or if a radio environment is poor, the size of the segmented data packet may be small.

(2) Error correction: The error correction is generally for AM transmission, for example, for applying an automatic repeat request (ARQ).

### 6. MAC layer

Similar to a function in 4G, a 5G MAC layer mainly provides a scheduling function, including resource scheduling, mapping between a logical channel and a transport channel, multiplexing/demultiplexing, and HARQ (uplink and downlink asynchronization).

### 7. PHY layer

Main functions of the physical layer may include: error detection, forward error correction (FEC), encryption and decryption, rate matching, physical channel mapping, adjustment and demodulation, frequency synchronization and time synchronization, radio measurement, and multi-input multi-output (MIMO) processing.

The following describes, in detail with reference to the accompanying drawings, the communication method provided in embodiments of this application. Steps shown by using dashed lines in embodiments of this application are all optional steps. The terminal apparatus in embodiments of this application may be, for example, the terminal apparatus in any one of FIG. 1 and FIG. 4 to FIG. 7. The access network apparatus may be, for example, the access network apparatus in any one of FIG. 1 and FIG. 4 to FIG. 7. The core network apparatus may be, for example, the core network apparatus in FIG. 1, FIG. 4, or FIG. 5. The first DC apparatus is, for example, the data control apparatus in FIG. 3 or the first DC apparatus in FIG. 4 or FIG. 5. For example, the second DC apparatus is the data control apparatus in FIG. 3 or the second DC apparatus in any one of FIG. 4 to FIG. 7, and the first DA apparatus is the data agent apparatus in FIG. 3 or the first DA apparatus in any one of FIG. 4 to FIG. 7. Optionally, in embodiments of this application, for a user plane protocol stack of the terminal apparatus, refer to the user plane protocol stack of the terminal apparatus in FIG. 8, and for a user plane protocol stack of the core network apparatus, refer to the user plane protocol stack of the core network apparatus in FIG. 8.

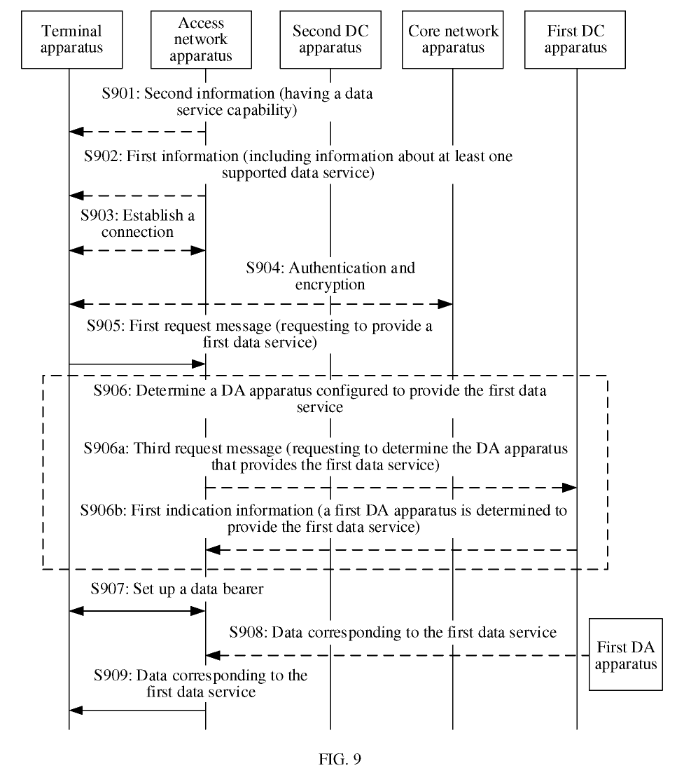

FIG. 9 is a diagram of a communication method according to an embodiment of this application. FIG. 9 shows S901 to S909. The following separately describes the steps.

S901: An access network apparatus sends second information. In this embodiment of this application, an example in which a terminal apparatus receives the second information from the access network apparatus is used for description. The second information indicates that the access network apparatus has a data service (DS) capability.

The access network apparatus may send the second information in a broadcast or multicast manner. Optionally, the second information may be carried in a system message. For example, the second information is carried in a system information block (SIB) 1 of the system message.

That the access network apparatus has the data service capability may be described as that the access network apparatus supports a data service. The data service is a service for performing various operations (such as at least one of collection, forwarding, and analysis) on data. It should be noted that the data service in embodiments of this application meets requirements of laws and regulations such as a personal information protection law (PIPL) and general data protection regulation (GDPR). A type of the data service may be determined based on a type of the data, or may be determined based on different operations performed on the data. The data service may include any type of data service in the following A1 to A8.

A1: Raw data collection: Raw data may be used as an input of artificial intelligence (AI), and the like.

A2: Data preprocessing: The data preprocessing includes preprocessing services such as data cleaning, filtering, convergence, and integration.

A3: Data storage: The data storage is used for providing a data storage function. For example, data may be stored by using a distributed ledge technology (DLT). For example, the data may be stored in a DA or a DSF. The DA is, for example, a first DA apparatus.

A4: Data privacy and security protection: The data privacy and security protection is used for providing an end-to-end data privacy and security protection technology.

A5: Data sharing (or transaction): The data sharing is used for providing data sharing and transaction.

A6: Data source tracing: The data source tracing is used for tracing data sources, for example, used for an auditing service and public key distribution.

A7: Data analysis: The data analysis is performed based on AI or machine learning (ML).

A8: Data dictionary: The data dictionary is used for providing a dataset service. For example, the data dictionary may be used for providing a wireless network feature dataset and a 6G network knowledge graph.

S902: The access network apparatus sends first information to the terminal apparatus. Correspondingly, the terminal apparatus receives the first information from the access network apparatus. The first information indicates information about at least one data service supported by the access network apparatus.

The access network apparatus may send the first information in a broadcast or multicast manner. Optionally, the first information may be carried in a system message, and specifically, for example, may be carried in a SIBX or a SIB1 of the system message, or the first information may be carried in an RRC message, or the first information may be carried in a NAS message. When both the second information and the first information are carried in the system message, the access network apparatus sends the system message, which is equivalent to synchronously sending the first information and the second information.

The information about the at least one data service may include an identifier of each data service in the at least one data service. The at least one data service may include a data service that can be directly or indirectly provided by the access network apparatus. For example, a DA apparatus may be deployed in the access network apparatus, and a data service that can be provided by the DA apparatus may belong to the data service that can be directly provided by the access network apparatus. Information about the data service that can be indirectly provided by the access network apparatus may be obtained by the access network apparatus from a DC apparatus (for example, a first DC apparatus and/or a second DC apparatus) that can communicate with the access network apparatus. The second DC apparatus may obtain, from a first DA apparatus, a data service that can be provided by the first DA apparatus.

In a possible implementation, that the first information indicates the information about the at least one data service supported by the access network apparatus is equivalent to notifying the terminal apparatus that the access network apparatus has the data service capability. In this case, step S901 may not be performed, that is, S901 is an optional step, and is shown by using a dashed line in FIG. 9. Alternatively, the terminal apparatus be pre-configured or pre-defined with the information about the at least one data service that can be supported by the access network apparatus. In this case, steps S901 and S902 may not be performed. In other words, both S901 and S902 are optional steps, and are shown by using dashed lines in FIG. 9.

S903: The terminal apparatus establishes a connection with the access network apparatus.

Optionally, S903 includes S903a and S903b. The following separately describes S903a and S903b.

S903a: The terminal apparatus sends a second request message to the access network apparatus. Correspondingly, the access network apparatus receives the second request message from the terminal apparatus. The second request message is for requesting to establish a connection. Optionally, the second request message indicates that a cause for requesting to establish the connection is to request to provide a data service. In other words, requesting a data service is a cause value for requesting to establish the connection by the terminal apparatus. In this way, a core network apparatus may determine that the terminal apparatus needs the data service. In this embodiment of this application, the terminal apparatus actively requires the access network apparatus to provide a data service, which may be referred to as a mobile originated data service (mo-DataService). In other words, the cause for requesting to establish the connection by the terminal apparatus is the mo-data service.

S903b: The access network apparatus sends a first response message to the terminal apparatus. Correspondingly, the terminal apparatus receives the first response message from the access network apparatus. The first response message indicates that the connection is established.

Optionally, the second request message is, for example, a message 3 (Msg3) in a random access procedure, and the first response message is, for example, a Msg4 in the random access procedure. The Msg3 and the Msg4 are, for example, messages in a four-step random access procedure. Alternatively, the second request message is, for example, a MsgA in a random access procedure, and the first response message is a MsgB in the random access procedure. The MsgA and the MsgB are, for example, messages in a two-step random access procedure.

In a possible implementation, before the terminal apparatus sends the second request message, the terminal apparatus may send a first random access preamble to the access network apparatus. Correspondingly, the access network apparatus receives the first random access preamble from the terminal apparatus. The access network apparatus sends a random access response (RAR) message to the terminal apparatus. Correspondingly, the terminal apparatus receives the RAR message from the access network apparatus. The RAR message is used for responding to the first random access preamble. The possible implementation is applicable to a case in which the second request message is, for example, the Msg3, and the first response message is, for example, the Msg4.

In a possible implementation, the first random access preamble may indicate to establish a connection for a data service.

For example, the first random access preamble belongs to a first random access preamble set, and any random access preamble in the first random access preamble set indicates to establish the connection for the data service. The terminal apparatus may be pre-configured or pre-defined with information about the first random access preamble set. For example, the access network apparatus configures the information about the first random access preamble set for the terminal apparatus. For example, the access network apparatus configures the first random access preamble set for the terminal apparatus based on the system message (such as the SIB1) or the RRC message. Alternatively, a protocol pre-defines the first random access preamble set in the terminal apparatus and the access network apparatus. After receiving the first random access preamble from the terminal apparatus, the access network apparatus may determine, based on the first random access preamble, that a data service needs to be provided for the terminal apparatus. The first random access preamble set includes, for example, random access preambles of a group C.

Optionally, the terminal device may further pre-configure or pre-define information about a second random access preamble set. Any random access preamble in the second random access preamble set is used for another service other than the data service, and the another service is, for example, a voice service or a video service. The second random access preamble set includes, for example, random access preambles of a group A.

In this possible implementation, the first random access preamble may be distinguished from a random access preamble corresponding to another service, so that a probability that the first random access preamble conflicts with the random access preamble corresponding to the another service is reduced.

S904: The core network apparatus performs authentication and encryption on the terminal apparatus.

For example, the terminal apparatus may send identity information of the terminal apparatus to the access network apparatus (for example, an AMF), or the access network apparatus has obtained identity information of the terminal apparatus in a process of establishing the connection with the terminal apparatus, and the access network apparatus may send the identity information of the terminal apparatus to the core network apparatus, so that the core network apparatus may perform authentication and encryption on the terminal apparatus based on the identity information.

When the terminal apparatus is in an idle mode or an inactive mode, the foregoing steps of S903 and S904 may be performed, to establish the connection between the terminal apparatus and the access network apparatus. When the terminal apparatus may have previously established a connection with the access network apparatus, for example, when the terminal apparatus is in a connected state, steps of S903 and S904 may not need to be performed, that is, S903 and S904 are optional steps, and are shown by using dashed lines in FIG. 9.

S905: The terminal apparatus sends a first request message to the access network apparatus. Correspondingly, the access network apparatus receives the first request message from the terminal apparatus.

The first request message is, for example, an RRC message or a NAS message. When S903 is performed, the terminal apparatus may send the first request message to the access network apparatus based on the connection established in S903. The first request message is for requesting to provide a first data service. The first data service is a data service needed by the terminal apparatus this time. The terminal apparatus may determine the first data service based on an actual requirement. For example, if the terminal apparatus needs to obtain sensing data, the terminal apparatus may determine that the first data service is collection of raw data, such as sensing data. For another example, if the terminal apparatus needs an analysis result of vehicle condition data, the terminal apparatus may determine that the first data service is vehicle condition data analysis.

It should be understood that the first data service includes one or more data services. When the first data service includes a plurality of data services, the plurality of data services may be a same data service, or may be a plurality of types of data services. This is not limited in embodiments of this application. In this embodiment of this application, an example in which the first data service includes one data service is used for description.

For example, the first request message may carry an identifier of the first data service. In this case, the terminal apparatus may request to provide the first data service based on the identifier of the first data service. Correspondingly, after determining the identifier of the first data service in the first request message, the access network apparatus may determine that the terminal apparatus requests the first data service.

S906: The access network apparatus determines a DA apparatus configured to provide the first data service. In this embodiment of this application, an example in which the DA apparatus that provides the first data service is the first DA apparatus is used. There are a plurality of manners in which the access network apparatus determines the DA apparatus, and the following separately describes the manners.

Manner 1: The access network apparatus determines the first DA apparatus through the first DC apparatus.

In Manner 1, S906 may include S906a and S906b. The following separately describes S906a and S906b.

S906a: The access network apparatus sends a third request message to the first DC apparatus. Correspondingly, the first DC apparatus receives the third request message from the access network apparatus. The third request message is for requesting to determine the DA apparatus that provides the first data service.

Optionally, when a DC apparatus (for example, the second DC apparatus) is deployed in the access network apparatus, the access network apparatus may directly communicate with the first DC apparatus. When no DC apparatus is deployed in the access network apparatus, the access network apparatus may communicate with the first DC apparatus through the second DC apparatus. In this case, in S906a, the access network apparatus may send the third request message to the second DC apparatus, and the second DC apparatus sends the third request message to the first DC apparatus.

In a possible implementation, before sending the third request message to the first DC apparatus, the second DC apparatus may determine that the first DC apparatus does not need to participate in the first data service. For a manner in which the second DC apparatus determines whether the first DC apparatus needs to participate in the first data service, refer to the following manner B1 or B2.

B1: The second DC apparatus determines, depending on whether the second DC apparatus can provide the first data service, whether the first DC apparatus needs to participate in the first data service.

For example, if the second DC apparatus determines that a DA apparatus managed by the second DC apparatus can provide the first data service, the second DC apparatus may determine that the first DC apparatus does not need to participate in the first data service; or if the second DC apparatus determines that a DA apparatus managed by the second DC apparatus cannot provide the first data service, the second DA apparatus may determine that the first DC apparatus participates in the first data service.

B2: The second DC apparatus determines, based on load balancing, whether the first DC apparatus needs to participate in the first data service.

For example, if determining that load of the second DC apparatus is less than or equal to load of the first DC apparatus, the second DC apparatus determines that the first DC apparatus does not need to participate in the first data service; or if determining that load of the second DC apparatus is greater than load of the first DC apparatus, the second DC apparatus determines that the first DC apparatus needs to participate in the first data service. In this way, load of the first DC apparatus and load of the second DC apparatus can be relatively balanced, to avoid overload of a DC apparatus. The manner B2 is applicable to a case in which both the second DC apparatus and the first DC apparatus can provide the first data service.

It should be understood that there may be a plurality of manners of determining whether the first DC apparatus needs to participate in the first data service. This is not limited in embodiments of this application.

S906b: The first DC apparatus sends first indication information to the access network apparatus. Correspondingly, the access network apparatus receives the first indication information from the first DC apparatus. The first indication information indicates that the first DA apparatus is determined to provide the first data service. After receiving the first indication information, the first DC apparatus may determine, from one or more DA apparatuses managed by the first DC apparatus, the DA apparatus that provides the first data service.

It should be understood that FIG. 9 shows steps in which the access network apparatus determines the first DA apparatus in the foregoing Manner 1. Actually, a manner in which the access network apparatus determines the first DA apparatus is not limited.

Manner 2: The access network apparatus determines the first DA apparatus through the second DC apparatus.

The access network apparatus may directly send a third request message to the second DC apparatus, and the second DC apparatus may determine, from one or more DA apparatuses managed by the second DC apparatus, the first DA apparatus that provides the first data service. After determining the first DA apparatus, the second DC apparatus may also send first indication information to the access network apparatus.

Before the second DC apparatus determines the first DA apparatus in Manner 2, optionally, the second DC apparatus may determine that the first DC apparatus does not need to participate in the first data service. For a manner of determining that the first DC apparatus does not need to participate in the first data service, refer to the manner B1 or B2 above. Repeated content is not listed herein again.

It should be understood that when the first data service includes the plurality of data services, a DA apparatus determined by the access network apparatus may be one or more DA apparatuses, that is, the first DA apparatus may be one or more DA apparatuses. Alternatively, when there is one first data service, there may be one or more DA apparatuses determined by the access network apparatus.

S907: The terminal apparatus sets up a data bearer (DB) with the access network apparatus. The data bearer is a logical channel for transmitting data. Any apparatus in the data bearer may provide a data service, that is, may perform a data operation (for example, at least one of collection, forwarding, and analysis). In addition, any two apparatuses in a network may set up a data bearer. The following describes a process of setting up the data bearer.

After determining that the first DA apparatus can provide the first data service, the access network apparatus may determine to set up the data bearer. For example, the access network apparatus may send a fifth request message to the terminal apparatus. Correspondingly, the terminal apparatus receives the fifth request message from the access network apparatus. The fifth request message is for requesting to set up the data bearer. For example, the fifth request message may be an RRC configuration message. Optionally, the fifth request message further indicates information about a resource occupied by the data bearer. The resource is, for example, a time-frequency resource. The terminal apparatus determines to set up the data bearer. For example, when the fifth request message indicates the information about the resource, the terminal apparatus may set up the data bearer based on the resource, or if the fifth request message does not indicate the information about the resource, the terminal apparatus may select an idle resource to set up the data bearer.

The terminal apparatus sends a third response message to the access network apparatus. Correspondingly, the access network apparatus receives the third response message from the terminal apparatus. The third response message indicates that the data bearer is set up. For example, the third response message may be an RRC configuration complete message. Optionally, the third response message may indicate information about a resource used by the terminal apparatus to set up the data bearer, to help the access network apparatus use the data bearer. It should be understood that a manner of setting up the data bearer is shown in this embodiment of this application, and actually, a specific manner of setting up the data bearer is not limited.

In a possible implementation, when the access network apparatus determines the first DA apparatus in Manner 1, after determining the first DA apparatus, the first DC apparatus may send the first indication information to the core network apparatus (for example, an AMF). The AMF may send the first indication information to the access network apparatus. After receiving the first indication information, the access network apparatus may determine to set up the data bearer with the terminal apparatus. Because the first indication information may be used to trigger the access network apparatus to perform a data bearer setup process, the first indication information may also be referred to as a data bearer setup request message.

After the access network apparatus sets up the data bearer with the terminal apparatus, the access network apparatus may send a data bearer setup message to the AMF, to notify the AMF that the data bearer between the access network apparatus and the terminal apparatus is successfully set up. After receiving the data bearer setup message, the AMF may send a data service acknowledgment message to the first DC apparatus. The data service acknowledgment message indicates that the first data service can be provided.

To ensure security of data transmission between the terminal apparatus and the access network apparatus, optionally, before the terminal apparatus sets up the data bearer with the access network apparatus, the access network apparatus may send a sixth request message to the terminal apparatus. Correspondingly, the terminal apparatus receives the sixth request message from the access network apparatus. The sixth request message indicates to start an encryption mode. The encryption mode is, for example, an advanced encryption standard (AES/AS). When the encryption mode is the AS, the sixth request message may also be referred to as an AS security mode command.

After starting the encryption mode, the terminal apparatus may send a fourth response message to the access network apparatus. Correspondingly, the access network apparatus may receive the fourth response message from the terminal apparatus. The fourth response message indicates that the terminal apparatus has started the encryption mode. In this way, subsequently, the access network apparatus may interact with the terminal apparatus in the encryption mode. When the encryption mode is the AS, the fourth response message may also be referred to as an advanced encryption standard security mode complete (AS security mode complete) message.

S908: The first DA apparatus sends data corresponding to the first data service to the access network apparatus. Correspondingly, the access network apparatus receives, from the first DA apparatus, the data corresponding to the first data service.

The first DA apparatus may send the data corresponding to the first data service to the access network apparatus through the AMF. Alternatively, the first DA apparatus may send the data corresponding to the first data service to the access network apparatus sequentially through the first DC apparatus and the second DC apparatus.

The data corresponding to the first data service is a result obtained by performing the first data service by the first DA apparatus, and the data corresponding to the first data service may also be referred to as a data service result. If types of first data services are different, content of data corresponding to the first data services is also different. For example, if the first data service is the data service shown in A1, the data corresponding to the first data service is raw data collected by the first DA apparatus. For another example, if the first data service is the data analysis shown in A7, the data corresponding to the first data service is a data analysis result obtained by the first DA apparatus through analysis. The first DA apparatus may perform the first data service in a plurality of manners. This is not specifically limited in embodiments of this application. For example, the first DA apparatus may be pre-configured or pre-defined with an AI model, and the first DA apparatus may perform the first data service by using the AI model.

In another possible implementation, if the first DA apparatus is deployed in the access network apparatus, that the first DA apparatus obtains the data corresponding to the first data service is equivalent to that the access network apparatus obtains the data of the first data service. In this case, the access network apparatus does not need to receive, from the first DA apparatus, the data corresponding to the first data service, that is, step S908 does not need to be performed. Therefore, S908 is an optional step, and is shown by using a dashed line in FIG. 9.

S909: The access network apparatus sends the data corresponding to the first data service to the terminal apparatus through the data bearer. Correspondingly, the terminal apparatus receives, from the access network apparatus through the data bearer, the data corresponding to the first data service.

In a possible implementation, after determining that the first data service ends, the access network apparatus may delete the data bearer. For example, after determining that the terminal apparatus successfully receives the data corresponding to the first data service, the access network apparatus determines that the first data service ends. Alternatively, after performing S909, the access network apparatus may set a timer. After the timer expires, the access network apparatus may determine that the first data service ends. Certainly, the access network apparatus determines, in a plurality of manners, that the first data service ends. This is not limited in embodiments of this application. Deleting the data bearer includes, for example, but is not limited to, releasing a resource occupied by the data bearer in the access network apparatus.

The access network apparatus may further indicate the terminal apparatus to delete the data bearer. For example, the access network apparatus may send a fourth request message to the terminal apparatus. Correspondingly, the terminal apparatus receives the fourth request message from the access network apparatus. The terminal apparatus deletes the data bearer, where deleting the data bearer includes, for example, but is not limited to, releasing a resource occupied by the data bearer in the terminal apparatus. The terminal apparatus may send a second response message to the access network apparatus. Correspondingly, the access network apparatus receives the second response message from the terminal apparatus. The second response message indicates that the data bearer is deleted. In this way, it is equivalent to completing a process of deleting the data bearer.

In this embodiment of this application, the access network apparatus sets up the data bearer only when the terminal apparatus needs to provide the first data service. This reduces time for maintaining the data bearer by the access network apparatus and the terminal apparatus, and reduces resource overheads of the access network apparatus and the terminal apparatus. In addition, the data bearer may be completed through only interaction between the access network apparatus and the terminal apparatus, without participation of the core network apparatus. Compared with establishing a PDU session, a manner of setting up the data bearer is more flexible and simple, and resource overheads for setting up the data bearer are also reduced. In addition, this embodiment of this application is applicable to various cases such as that the terminal apparatus is in a non-connected state or a connected state. In addition, in this embodiment of this application, the access network apparatus may flexibly determine, in a plurality of manners, the DA apparatus that provides the first data service, thereby increasing flexibility of processing the first data service. In addition, the terminal apparatus may actively request a data service from the access network apparatus at any time, thereby improving flexibility of obtaining, by the terminal apparatus, data corresponding to the data service. This embodiment of this application is applicable to a case in which the terminal apparatus is a vehicle-mounted device, and is used in various data request scenarios in which vehicle condition information, sensing data, and/or the like are/is periodically or irregularly requested from the access network apparatus. In other words, this embodiment of this application has good adaptability.

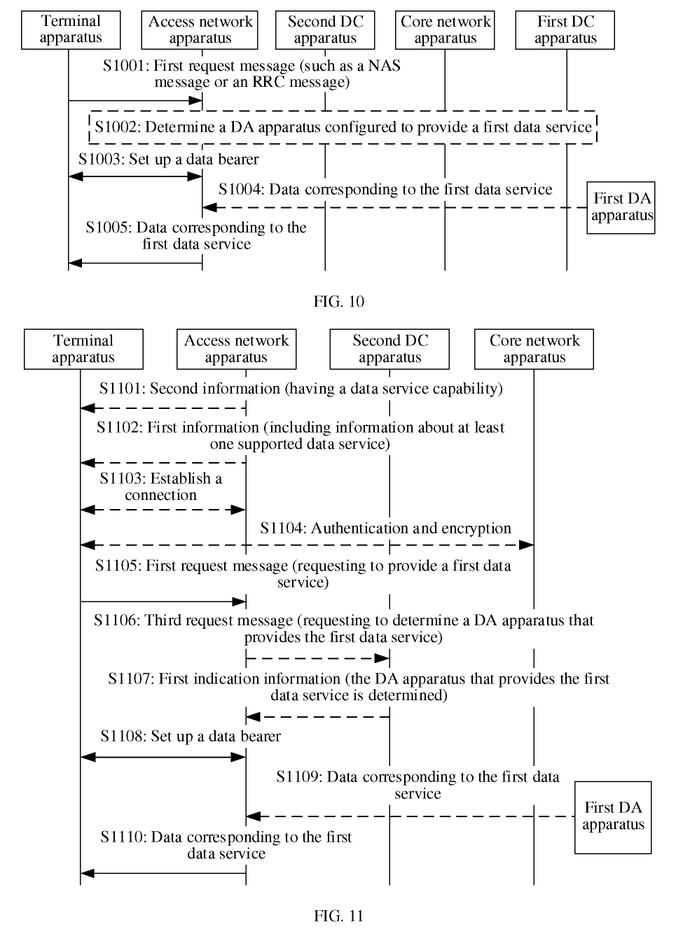

The following describes a process of the communication method provided in embodiments of this application by using an example in which the terminal apparatus is in a connected state. FIG. 10 is a diagram of a structure of a communication method according to an embodiment of this application. FIG. 10 shows S1001 to S1005. The following separately describes the steps.

S1001: The terminal apparatus sends a first request message to an access network apparatus. Correspondingly, the access network apparatus receives the first request message from the terminal apparatus. The first request message is, for example, a NAS message or an RRC message.

For content of the first request message, refer to content of the first request message in S905 in FIG. 9 above. For content of sending the first request message, refer to content of sending the first request message in S905 in FIG. 9 above.

S1002: The access network apparatus determines a DA apparatus configured to provide a first data service.

For a manner of determining the DA apparatus by the access network apparatus, refer to content of determining the DA apparatus in S906 in FIG. 9 above.

S1003: The terminal apparatus sets up a data bearer with the access network apparatus.

For content of the data bearer, refer to content of the data bearer in S907 in FIG. 9 above, and for a process of setting up the data bearer, refer to content of setting up the data bearer in S907 in FIG. 9 above.

S1004: The first DA apparatus sends data corresponding to the first data service to the access network apparatus. Correspondingly, the access network apparatus receives, from the first DA apparatus, the data corresponding to the first data service.

For content of determining, by the first DA apparatus, the data corresponding to the first data service, refer to content of determining, by the first DA apparatus, the data corresponding to the first data service in FIG. 9 above. For content of the data corresponding to the first data service, refer to content of the data corresponding to the first data service in S908 in FIG. 9 above.

S1004 is an optional step, and is shown by using a dashed line in FIG. 10.

S1005: The access network apparatus sends the data corresponding to the first data service to the terminal apparatus through the data bearer. Correspondingly, the terminal apparatus receives, from the access network apparatus through the data bearer, the data corresponding to the first data service.

In a possible implementation, the access network apparatus may delete the data bearer and indicate the terminal apparatus to delete the data bearer. For deleting the data bearer by the access network apparatus, refer to content of deleting the data bearer in S909 in FIG. 9 above. For content of indicating, by the access network apparatus, the terminal apparatus to delete the data bearer, refer to content of indicating the terminal apparatus to delete the data bearer in S909 in FIG. 9 above.

In this embodiment of this application, the access network apparatus sets up the data bearer after determining that the terminal apparatus needs a data service, thereby reducing duration for maintaining the data bearer and reducing resource overheads. In addition, in a case in which the terminal apparatus is already in the connected state, the terminal apparatus does not need to establish a connection with the access network apparatus, thereby reducing a quantity of interactions between the terminal apparatus and the access network apparatus. In addition, the solutions provided in embodiments of this application are applicable to the case in which the terminal apparatus is in the connected state.

The following describes a process of the communication method provided in embodiments of this application by using an example in which the access network apparatus determines the first DA apparatus in Manner 2 above. FIG. 11 is a diagram of a communication method according to an embodiment of this application. FIG. 11 shows S1101 to S1110. The following separately describes the steps.

S1101: An access network apparatus sends second information to a terminal apparatus. Correspondingly, the terminal apparatus receives the second information from the access network apparatus. For content of the second information, refer to content of the second information in S901 in FIG. 9 above.

S1102: The access network apparatus sends first information to the terminal apparatus. Correspondingly, the terminal apparatus receives the first information from the access network apparatus. For content of the first information, refer to content of the first information in S902 in FIG. 9 above.

S1103: The terminal apparatus establishes a connection with the access network apparatus. For a manner of establishing the connection, refer to content of establishing the connection in S903 in FIG. 9 above.

S1104: The core network apparatus performs authentication and encryption on the terminal apparatus.

For a manner of authentication and encryption, refer to content of the authentication and encryption in S904 in FIG. 9 above.

S1101 to S1104 are all optional steps, and are shown by using dashed lines in FIG. 11.

S1105: The terminal apparatus sends a first request message to the access network apparatus. Correspondingly, the access network apparatus receives the first request message from the terminal apparatus. For content of the first request message, refer to content of the first request message in S905 in FIG. 9 above.

S1106: The access network apparatus sends a third request message to a second DC apparatus. Correspondingly, the second DC apparatus receives the third request message from the access network apparatus. For content of the third request message, refer to content of the third request message in S906a in FIG. 9 above.

S1107: The second DC apparatus sends first indication information to the access network apparatus. Correspondingly, the access network apparatus receives the first indication information from the second DC apparatus. For content of the first indication information, refer to content of the first indication information in S906b in FIG. 9 above.

In this embodiment of this application, an example in which the second DC apparatus directly determines a DA apparatus that provides a first data service, and the DA apparatus that provides the first data service is a first DA apparatus is used. For a manner in which the second DC apparatus determines the first DA apparatus, refer to content of determining the first DA apparatus by the first DC apparatus in S906 in FIG. 9 above.

S1106 and S1107 are optional steps, and are shown by using dashed lines in FIG. 11.

S1108: The terminal apparatus sets up a data bearer with the access network apparatus. For content of the data bearer, refer to content of the data bearer in S907 in FIG. 9 above. For content of setting up the data bearer, refer to content of setting up the data bearer in S907 in FIG. 9 above.

S1109: The first DA apparatus sends data corresponding to the first data service to the access network apparatus. Correspondingly, the access network apparatus receives, from the first DA apparatus, the data corresponding to the first data service. For content of the data corresponding to the first data service, refer to content of the data corresponding to the first data service in S908 in FIG. 9 above, and for a manner in which the first DA apparatus sends a data service result, refer to content of sending the data service result in S909 in FIG. 9 above.

S1109 is an optional step, and is shown by using a dashed line in FIG. 11.

S1110: The access network apparatus sends the data corresponding to the first data service to the terminal apparatus. Correspondingly, the terminal apparatus receives, from the access network apparatus, the data corresponding to the first data service.

In a possible implementation, the access network apparatus may delete the data bearer and indicate the terminal apparatus to delete the data bearer. For content of deleting the data bearer by the access network apparatus, refer to content of deleting the data bearer in S909 in FIG. 9 above. For content of indicating, by the access network apparatus, the terminal apparatus to delete the data bearer, refer to content of indicating the terminal apparatus to delete the data bearer in S909 in FIG. 9 above.

In this embodiment of this application, the access network apparatus sets up the data bearer only after determining that the terminal apparatus needs a data service, thereby reducing duration for maintaining the data bearer and reducing resource overheads. In addition, the access network apparatus may determine the first DA apparatus through the second DC apparatus, without participation of a core network in a data service process. This simplifies a process of providing a data service for the terminal apparatus, and reduces costs of providing the data service for the terminal apparatus.

It may be understood that, to implement the functions in the foregoing embodiments, the terminal apparatus and the access network apparatus include corresponding hardware structures and/or software modules for performing the functions. A person skilled in the art should be easily aware that, in this application, the units and method steps in the examples described with reference to embodiments disclosed in this application can be implemented by hardware or a combination of hardware and computer software. Whether a function is performed by hardware or hardware driven by computer software depends on particular application scenarios and implementation constraint conditions of the technical solutions.

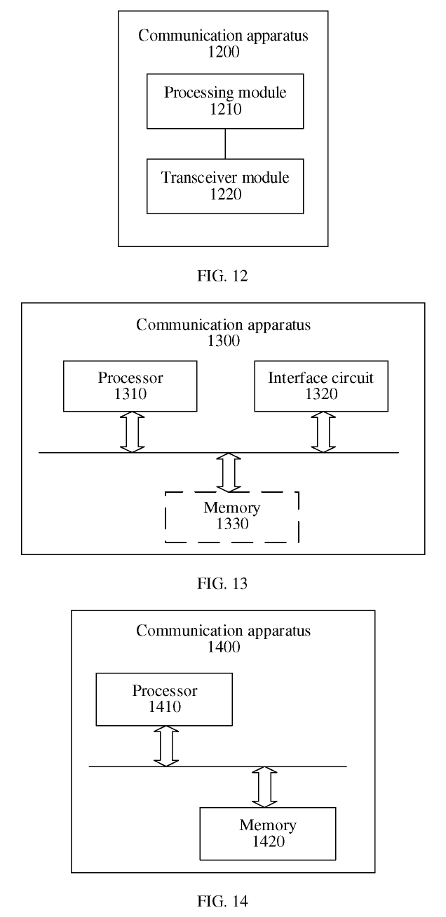

FIG. 12 is a diagram of a structure of a communication apparatus according to an embodiment of this application. The communication apparatus may be configured to implement a function of any access network apparatus or terminal apparatus in the foregoing method embodiments, and therefore can also implement beneficial effects of the foregoing method embodiments. In this embodiment of this application, the communication apparatus may be the access network apparatus in any one of FIG. 1 and FIG. 4 to FIG. 7, or a software or hardware module (such as a chip) used in the access network apparatus shown in FIG. 1, or may be the terminal apparatus in any one of FIG. 1 and FIG. 4 to FIG. 7, or a software or hardware module (such as a chip) used in the terminal apparatus shown in FIG. 1.

As shown in FIG. 12, the communication apparatus 1200 includes a processing module 1210 and a transceiver module 1220.

In a possible embodiment, the communication apparatus 1200 is configured to implement functions of the access network apparatus in the method embodiment shown in FIG. 9, FIG. 10, or FIG. 11.

When the communication apparatus 1200 is configured to implement the functions of the access network apparatus in the method embodiment shown in FIG. 9, the processing module 1210 may be configured to control the transceiver module 1220 to receive a first request message, set up a data bearer, and send data corresponding to a first data service to the terminal apparatus. For content of the first request message, refer to content of the first request message in S905 in FIG. 9 above. For content of the data bearer, refer to related content of the data bearer in S907 in FIG. 9 above. For content of the data corresponding to the first data service, refer to content of the data corresponding to the first data service in S908 or S909 in FIG. 9 above.

Optionally, the transceiver module 1220 is further configured to send second information and first information, and establish a connection with the terminal apparatus. The processing module 1210 is further configured to determine a DA apparatus that provides the first data service, and the like. For content of the second information, refer to content of the second information in S901 in FIG. 9 above. For content of the first information, refer to content of the first information in S902 in FIG. 9 above. For a manner of establishing the connection, refer to content of establishing the connection in S903 above. For content of determining the DA apparatus that provides the first data service, refer to content of determining a first DA apparatus in S906 above.

For content of S901 to S903 and S905 to S909, refer to content in FIG. 9 above. Repeated content is not listed again.

When the communication apparatus 1200 is configured to implement the functions of the access network apparatus in the method embodiment shown in FIG. 10, under control of the processing module 1210, the transceiver module 1220 may receive the first request message, set up the data bearer, and send the data corresponding to the first data service to the terminal apparatus. For content of the first request message, refer to content of the first request message in S1001 in FIG. 10. For content of setting up the data bearer, refer to content of setting up the data bearer in S1003 in FIG. 10 above. For content of the data corresponding to the first data service, refer to content of the data corresponding to the first data service in S1005 in FIG. 10 above.

For related content of S1001 to S1005, refer to content in FIG. 10 above. Repeated content is not listed again.

When the communication apparatus 1200 is configured to implement the functions of the access network apparatus in the method embodiment shown in FIG. 11, the processing module 1210 may be configured to control the transceiver module 1220 to receive the first request message, set up the data bearer, and send the data corresponding to the first data service to the terminal apparatus. For content of the first request message, refer to content of the first request message in S1105 in FIG. 11 above. For content of setting up the data bearer, refer to content of setting up the data bearer in S1108 in FIG. 11 above. For content of the data corresponding to the first data service, refer to content of the data corresponding to the first data service in S1110 in FIG. 11 above.

Optionally, the transceiver module 1220 is further configured to send the second information and the first information, and establish the connection with the terminal apparatus. The processing module 1210 is further configured to determine the DA apparatus that provides the first data service. For content of the second information, refer to content of the second information in S1101 in FIG. 11 above. For content of the first information, refer to content of the first information in S1102 in FIG. 11 above. For content of establishing the connection, refer to content of establishing the connection in S1103 in FIG. 11. For content of determining the DA apparatus that provides the first data service, refer to content of determining the DA apparatus that provides the first data service in S1106 and S1107 in FIG. 11 above.

For related content of S1101 to S1103 and S1105 to S1110, refer to content in FIG. 11 above. Repeated content is not listed again.

In another possible embodiment, the communication apparatus 1200 is configured to implement the functions of the terminal apparatus in the method embodiment shown in FIG. 9, FIG. 10, or FIG. 11.

When the communication apparatus 1200 is configured to implement the functions of the terminal apparatus in the method embodiment shown in FIG. 9, the processing module 1210 may be configured to control the transceiver module 1220 to send a first request message, set up a data bearer, and receive data corresponding to a first data service. For content of the first request message, refer to content of the first request message in S905 in FIG. 9 above. For content of the data bearer, refer to related content of the data bearer in S907 in FIG. 9 above. For content of the data corresponding to the first data service, refer to content of the data corresponding to the first data service in S908 in FIG. 9 above. Repeated content is not listed again. Optionally, the transceiver module 1220 is further configured to receive second information and first information, establish a connection with the access network apparatus, and the like. For content of the second information, refer to content of the second information in S901 in FIG. 9 above. For content of the first information, refer to content of the first information in S902 in FIG. 9 above. For a manner of establishing the connection, refer to content of establishing the connection in S903 above.

For content of S901 to S903, S905, and S907 to S909, refer to content in FIG. 9 above. Repeated content is not listed again.

When the communication apparatus 1200 is configured to implement the functions of the terminal apparatus in the method embodiment shown in FIG. 10, the processing module 1210 may be configured to control the transceiver module 1220 to send the first request message, set up the data bearer, and receive the data corresponding to the first data service. For content of the first request message, refer to content of the first request message in S1001 in FIG. 10. For content of setting up the data bearer, refer to content of setting up the data bearer in S1003 in FIG. 10. For content of the data corresponding to the first data service, refer to content of the data corresponding to the first data service in S1005 in FIG. 10 above.

For related content of S1001 to S1005, refer to content in FIG. 10 above. Repeated content is not listed again.

When the communication apparatus 1200 is configured to implement the functions of the terminal apparatus in the method embodiment shown in FIG. 11, the processing module 1210 may be configured to control the transceiver module 1220 to send the first request message, set up the data bearer, and receive the data corresponding to the first data service. For content of the first request message, refer to content of the first request message in S1105 in FIG. 11 above. For content of setting up the data bearer, refer to content of setting up the data bearer in S1108 in FIG. 11 above. For content of the data corresponding to the first data service, refer to content of the data corresponding to the first data service in S1110 in FIG. 11 above.

Optionally, the transceiver module 1220 is further configured to receive the second information and the first information, establish the connection with the access network apparatus, and the like. For content of the second information, refer to content of the second information in S1101 in FIG. 11 above. For content of the first information, refer to content of the first information in S1102 in FIG. 11. For content of establishing the connection, refer to content of establishing the connection in S1103 in FIG. 11 above.

For related content of S1101 to S1103 and S1105 to S1110, refer to content in FIG. 11 above. Repeated content is not listed again.

FIG. 13 is diagram of a structure of another communication apparatus according to an embodiment of this application. The communication apparatus 1300 includes a processor 1310 and an interface circuit 1320. The processor 1310 is coupled to the interface circuit 1320. It may be understood that the interface circuit 1320 may be a transceiver or an input/output interface. Optionally, the communication apparatus 1300 may further include a memory 1330, configured to store instructions executed by the processor 1310, store input data needed by the processor 1310 to run the instructions, or store data generated after the processor 1310 runs the instructions.

When the communication apparatus 1300 is configured to implement any communication method described above, for example, the communication method shown in FIG. 9, FIG. 10, or FIG. 11 above, the processor 1310 is configured to implement the function of the processing module 1210, and the interface circuit 1320 is configured to implement the function of the transceiver module 1220.

When the communication apparatus is a chip used in the terminal apparatus, the terminal chip implements the function of the terminal apparatus in the foregoing method embodiment. The chip receives information from another module (for example, a radio frequency module or an antenna) in the terminal, where the information is sent by the access network apparatus to the terminal apparatus. Alternatively, the chip sends information to another module (for example, a radio frequency module or an antenna) in the terminal, where the information is sent by the terminal apparatus to the access network apparatus.

When the communication apparatus is a module used in the access network apparatus, the module implements the function of the access network apparatus in the foregoing method embodiment. The module receives information from another module (for example, a radio frequency module or an antenna) in the access network apparatus, where the information is sent by the terminal apparatus to the access network apparatus; or the module sends information to another module (for example, a radio frequency module or an antenna) in a base station, where the information is sent by the access network apparatus to the terminal apparatus. The module herein may be a baseband chip in the access network apparatus, or may be a DU or another module. The DU herein may be a DU in an open radio access network (O-RAN) architecture.

It may be understood that the processor in embodiments of this application may be a central processing unit (CPU), or may be another general-purpose processor, a digital signal processor (DSP), an application specific integrated circuit (ASIC), a field programmable gate array (FPGA) or another programmable logic device, a transistor logic device, a hardware component, or any combination thereof. The general-purpose processor may be a microprocessor or any regular processor or the like. In embodiments of this application, the memory may include a volatile memory, for example, a random access memory (RAM). The memory may further include a non-volatile memory, for example, a read-only memory (ROM), a flash memory, a hard disk drive (HDD), or a solid-state drive (SSD).

An embodiment of this application provides another example of a communication apparatus. The communication apparatus includes at least one processor and at least one memory. The at least one processor is coupled to the at least one memory. The at least one memory is configured to store instructions. When the instructions are executed by the at least one processor, the communication apparatus is caused to perform the method in the foregoing embodiments. For example, the communication apparatus includes one processor and one memory. As shown in FIG. 14, the communication apparatus 1400 includes one processor 1410 and one memory 1420. The processor 1410 is coupled to the memory 1420. The memory 1420 stores instructions. When the instructions stored in the memory 1420 is executed by the processor 1410, the communication apparatus 1400 performs any communication method in the foregoing embodiments, for example, the communication method shown in FIG. 9, FIG. 10, or FIG. 11 above. Optionally, the communication apparatus 1400 may perform the communication method performed by the terminal apparatus shown in FIG. 9, FIG. 10, or FIG. 11 above, or may perform the communication method performed by the access network apparatus shown in FIG. 9, FIG. 10, or FIG. 11 above. For an implementation of the processor 1410, refer to content of the processor 1310 in FIG. 13 above. For an implementation of the memory 1420, refer to content of the memory 1330 in FIG. 13 above.

An embodiment of this application provides a communication system. The communication system includes any terminal apparatus and any access network apparatus above. Optionally, the communication system further includes the first DC apparatus, first DA apparatus, second DC apparatus above, and the like. For functions of the terminal apparatus, the access network apparatus, the first DC apparatus, the first DA apparatus, and the second DC apparatus, refer to content described in FIG. 9, FIG. 10, or FIG. 11 above.

An embodiment of this application provides a chip system. The chip system includes a processor and an interface. The processor is configured to invoke instructions from the interface and run the instructions. When executing the instructions, the processor implements any one of the foregoing communication methods, for example, the communication method shown in FIG. 9, FIG. 10, or FIG. 11 above.

An embodiment of this application provides a computer-readable storage medium. The computer-readable storage medium is configured to store a computer program or instructions. When the computer program or the instructions are run, any one of the foregoing communication methods is implemented, for example, the communication method shown in FIG. 9, FIG. 10, or FIG. 11 above is implemented.

An embodiment of this application provides a computer program product including instructions. When the computer program product is run on a computer, any one of the foregoing communication methods is implemented, for example, the communication method in FIG. 9, FIG. 10, or FIG. 11 above is implemented.

The method steps in embodiments of this application may be implemented in hardware, or may be implemented in software instructions that may be executed by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk drive, a removable hard disk, a CD-ROM, or any other form of storage medium well-known in the art. For example, a storage medium is coupled to a processor, so that the processor can read information from the storage medium and write information into the storage medium. The storage medium may alternatively be a component of the processor. The processor and the storage medium may be disposed in an ASIC. In addition, the ASIC may be located in a base station or a terminal. The processor and the storage medium may exist in a base station or terminal as discrete components.

All or some of the foregoing embodiments may be implemented by using software, hardware, firmware, or any combination thereof. When software is used to implement embodiments, all or a part of embodiments may be implemented in a form of a computer program product. The computer program product includes one or more computer programs or instructions. When the computer programs or the instructions are loaded and executed on a computer, the procedures or functions in embodiments of this application are all or partially executed. The computer may be a general-purpose computer, a dedicated computer, a computer network, a network device, user equipment, or another programmable apparatus. The computer program or instructions may be stored in a computer-readable storage medium, or may be transmitted from a computer-readable storage medium to another computer-readable storage medium. For example, the computer program or instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk drive, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In embodiments of this application, unless otherwise stated or there is a logic conflict, terms and/or descriptions in different embodiments are consistent and may be mutually referenced, and technical features in different embodiments may be combined into a new embodiment based on an internal logical relationship thereof.

It may be understood that various numbers in embodiments of this application are merely used for differentiation for ease of description, and are not used to limit the scope of embodiments of this application. Sequence numbers of the foregoing processes do not mean a performing sequence, and the sequence of performing the processes should be determined based on functions and internal logic of the processes.

1. A communication method applied to an access network apparatus, the method comprising:
receiving, from a terminal apparatus, a first request message for requesting to provide a first data service;
setting up a data bearer with the terminal apparatus; and
exchanging, with the terminal apparatus through the data bearer, data corresponding to the first data service.

2. The method according to claim 1, further comprising:
sending first information about at least one data service supported by the access network apparatus, wherein the first data service is one of the at least one data service.

3. The method according to claim 1, further comprising:
receiving a second request message from the terminal apparatus, wherein the second request message is for requesting to establish a connection, and the second request message indicates that a cause for requesting to establish the connection is to request to provide a data service; and
sending a first response message to the terminal apparatus, wherein the first response message indicates that the connection is established, and the first request message from the terminal apparatus is received through the connection.

4. The method according to claim 3, further comprising:
receiving a first random access preamble from the terminal apparatus, wherein the first random access preamble indicates to establish the connection for the data service; and
sending a random access response message to the terminal apparatus.

5. The method according to claim 1, further comprising:
sending a third request message to a first data control apparatus, wherein the third request message is for requesting to determine a data agent apparatus that provides the first data service; and
receiving first indication information from the first data control apparatus, wherein the first indication information indicates that a first data agent apparatus is determined to provide the first data service.

6. The method according to claim 5, wherein the third request message is sent to the first data control apparatus through a second data control apparatus.

7. The method according to claim 1, further comprising:
determining, through a second data control apparatus, a first data agent apparatus that provides the first data service; and
receiving first indication information from the second data control apparatus, wherein the first indication information indicates that the first data agent apparatus is determined to provide the first data service.

8. The method according to claim 1, wherein the first request message is a radio resource control (RRC) message or a non-access stratum (NAS) message.

9. The method according to claim 1, further comprising:
sending second information indicating that the access network apparatus has a data service capability.

10. The method according to claim 1, wherein after exchanging, with the terminal apparatus through the data bearer, the data corresponding to the first data service, the method further comprises:
deleting the data bearer, and sending a fourth request message, indicating to delete the data bearer, to the terminal apparatus; and
receiving a second response message from the terminal apparatus, wherein the second response message indicates that the data bearer is deleted.

11. A communication method, comprising:
sending a first request message, for requesting to provide a first data service, to an access network apparatus;
setting up a data bearer with the access network apparatus; and
exchanging, with the access network apparatus through the data bearer, data corresponding to the first data service.

12. The method according to claim 11, further comprising:
receiving first information from the access network apparatus, wherein the first information comprises information about at least one data service supported by the access network apparatus, and the first data service is one of the at least one data service.

13. The method according to claim 11, further comprising:
sending a second request message to the access network apparatus, wherein the second request message is for requesting to establish a connection, and the second request message indicates that a cause for requesting to establish the connection is to request to provide a data service; and
receiving a first response message from the access network apparatus, wherein the first response message indicates that the connection is established, and the first request message is sent to the access network apparatus through the connection.

14. The method according to claim 13, further comprising:
sending a first random access preamble, indicating to establish the connection for the data service, to the access network apparatus; and
receiving a random access response message from the access network apparatus.

15. The method according to claim 11, wherein the first request message is a radio resource control (RRC) message or a non-access stratum (NAS) message.

16. The method according to claim 11, further comprising:
receiving second information indicating that the access network apparatus has a data service capability.

17. The method according to claim 11, wherein after exchanging, with the access network apparatus through the data bearer, the data corresponding to the first data service, the method further comprises:
receiving a fourth request message, indicating to delete the data bearer, from the access network apparatus;
deleting the data bearer; and
sending a second response message, indicating that the data bearer is deleted, to the access network apparatus.

18.A communication apparatus, comprising:
processing circuitry including at least a processor, wherein the processing circuitry is configured to:
receive a first request message from a terminal apparatus, wherein the first request message is for requesting to provide a first data service;
set up a data bearer with the terminal apparatus; and
exchange, with the terminal apparatus through the data bearer, data corresponding to the first data service.

19. The apparatus according to claim 18, wherein the processing circuitry is further configured to:
send first information having information about at least one data service supported by the access network apparatus, and the first data service is one of the at least one data service.

20. The apparatus according to claim 18, wherein the processing circuitry is further configured to:
receive a second request message from the terminal apparatus, wherein the second request message is for requesting to establish a connection, and the second request message indicates that a cause for requesting to establish the connection is to request to provide a data service; and
send a first response message to the terminal apparatus, wherein the first response message indicates that the connection is established, and the first request message from the terminal apparatus is received through the connection.
